(19) United States
(12) Patent Application Publication
(10) Pub. No.: US 2010/0030938 A1
(43) Pub. Date: Feb. 4, 2010

(54) CONTROLLER AND METHOD FOR DIRECT MEMORY ACCESS

(75) Inventor: Cheok Yan Goh, Hsinchu County (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, Hsinchu County (TW)

(21) Appl. No.: 12/471,002

(22) Filed: May 22, 2009

(30) Foreign Application Priority Data
Jul. 29, 2008 (TW) 097128569

(51) Int. Cl. G06F 13/22; G06F 13/24

(52) U.S. Cl. 710/220; 710/260

(57) ABSTRACT

A DMA controlling method comprises the steps of: building a linking table, wherein the linking table records the status of each memory block and of a pointer pointing to a next memory block; activating a first memory block; receiving an interrupt signal and linking to a next associated memory block after the first memory block finishes a data transfer; activating the next associated block; and updating the linking table to release the first memory block for reuse.

### BACKGROUND OF THE INVENTION

1. Field of the Invention

The present invention relates to a direct memory access (DMA) mechanism, and more particularly, to a DMA controller and DMA control method.

2. Description of the Related Art

DMA is a unique data transfer technique between memory and peripheral devices. This technique allows the peripheral devices to directly transfer data to the memory through system buses without assistance from the CPU. Direct memory access controllers (DMAC), in hardware or software form, are commonly responsible for managing data transfer to and from the memory module. A DMAC usually has multiple DMA channels, each corresponding to a separate memory block of the memory module.

FIG. 1 shows a timing chart of accessing data from memory. First, the DMAC activates one DMA access, as shown in step S12. After the data transfer is completed, the necessary time interval is marked as T1. Subsequently, the memory module sends an interrupt signal to the DMAC. When the DMAC receives the interrupt signal from the memory module, the DMAC resets the corresponding DMA channel to prepare for the next DMA transfer, as shown in S14, and the necessary time interval is marked as T2.

One problem with the conventional transfer method is that the availability of each DMA channel has to be reset by the DMAC after each DMA channel activity, and such mechanism affects the throughput of the system. In addition, if T1 is too long, the necessary stack which is used to temporarily store the transferred data will miss some data due to overflow. Furthermore, because the real-time requirements and transfer bandwidth for each peripheral device are different, designing a universal memory access mechanism capable of adapting to all kinds of situations will unavoidably waste hardware resources.

### SUMMARY OF THE INVENTION

A direct memory access (DMA) controlling method in accordance with one embodiment of the present invention comprises the steps of: building a linking table, wherein the linking table records the status of each memory block and a pointer pointing to a next memory block; activating a first memory block; receiving an interrupt signal and linking to a next associated memory block after the first memory block finishes a data transfer; activating the next associated block; and updating the linking table to release the first memory block for reuse.

A DMA controller in accordance with one embodiment of the present invention comprises a linking table configured to record the status of each memory block and a pointer pointing to a next associated memory block. The DMA controller initializes the status of each memory block and the pointer, then updates a transfer status of a memory block after receiving an interrupt signal from the memory block, and finally accesses the next associated memory block as indicated by the pointer.

A memory system in accordance with one embodiment of the present invention comprises a memory module and a DMA controller. The DMA controller is configured to activate the status of each memory block and a pointer pointing to a next associated memory block, to update a transfer state of a memory block after receiving an interrupt signal from the memory block, and to access the next associated memory block as indicated by the pointer.

### BRIEF DESCRIPTION OF THE DRAWINGS

The invention will be described according to the appended drawings in which:

FIG. 1 shows a timing chart of accessing data from the memory;

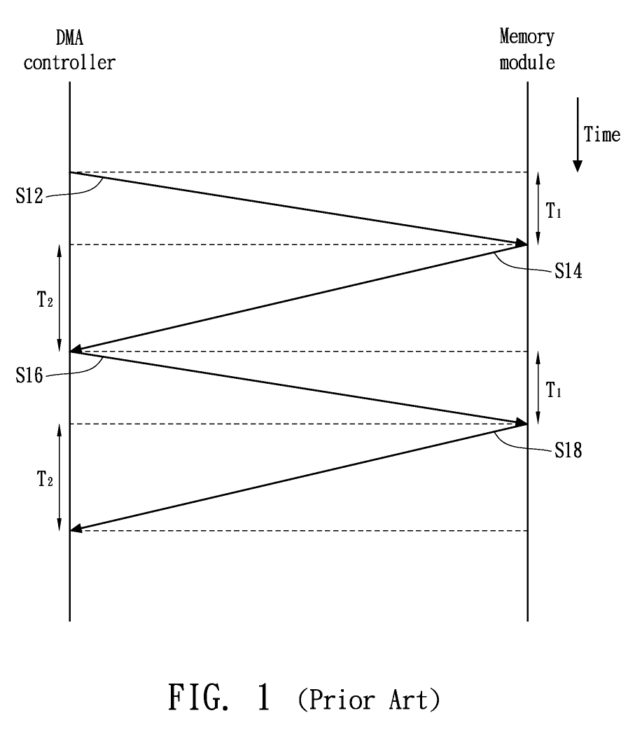

FIG. 2 shows a flow chart of a DMA control method in accordance with one embodiment of the present invention;

FIG. 3 shows a timing chart of the DMA control method in accordance with the present invention; and

FIG. 4 shows a memory system in accordance with one embodiment of the present invention.

### PREFERRED EMBODIMENT OF THE PRESENT INVENTION

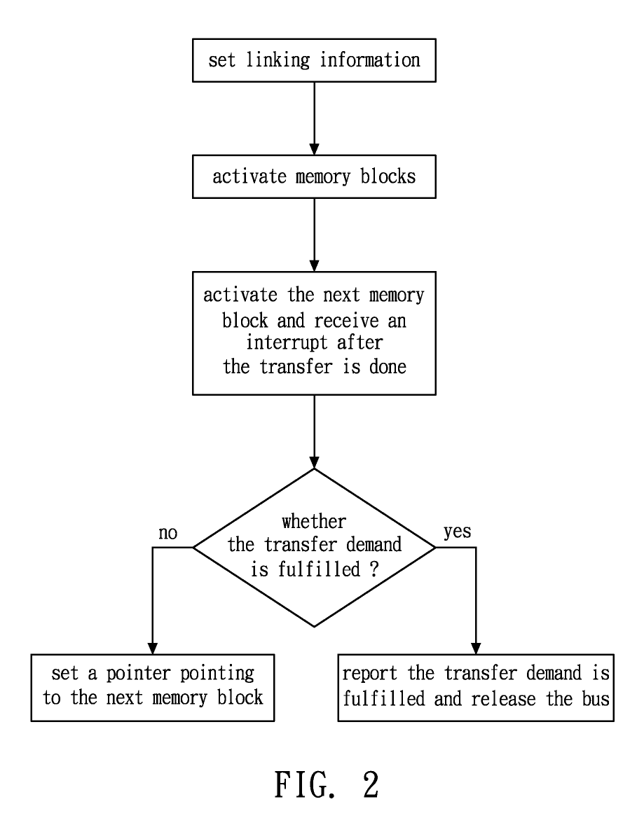

FIG. 2 shows a flow chart of a DMA control method in accordance with one embodiment of the present invention. First, a linking table is built to record the status of each memory block and a pointer pointing to the next memory block. Second, a memory block is activated in accordance with the linking table. Third, after the data transfer from the memory block is completed, an interrupt signal with respect to the memory block is received, and the next memory block is activated as indicated by the pointer. Finally, the linking table is updated and the memory block that sends an interrupt signal is in a linkable condition.

For example, at the start of the DMA process, the contents of the linking table are as follows:

| | Block activating | | |
|---|---|---|---|
| Block number | state | Block mask state | Pointer |
| 0 | H | L | 1 |
| 1 | H | H | 2 |
| 2 | H | H | 0 |

When the field of the block activating state of a memory block is marked as “H,” the block is settable. When the field of the block mask state of a memory block is marked as “H,” the block has not yet been activated; otherwise if marked as “L,” the block has been activated.

In accordance with the above table, only the block mask state of the memory block 0 is indicated as “L,” so the memory block 0 starts to transfer data. Since the pointer indicates the next memory block candidate is memory block 1, the block mask state of the memory block 1 will be set to “L” to provide accessibility to the DMAC after the data transfer of the memory block 0 is completed. The memory block 0 then sends an interrupt signal to DMAC, and the DMAC updates the block activating state and block mask state to retain the accessibility.

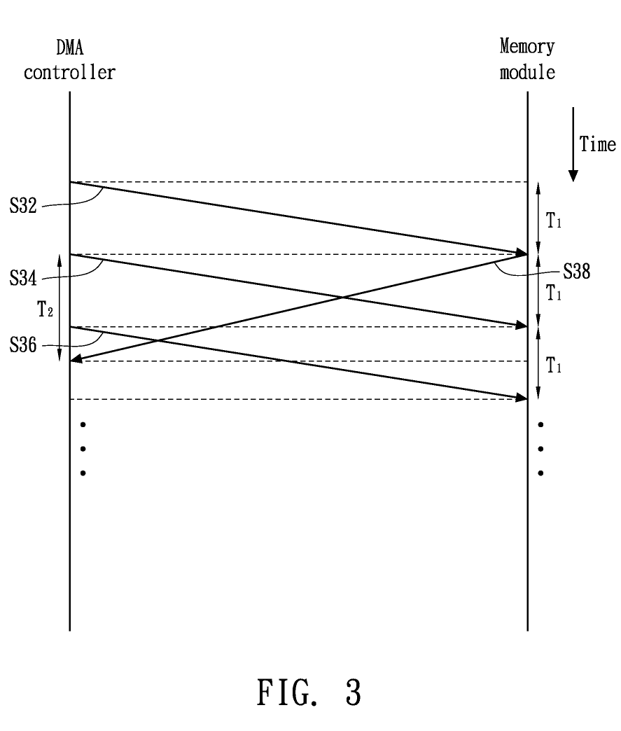

FIG. 3 shows a timing chart of the DMA control method in accordance with the present invention. In step S32, the memory block 0 of the memory module is activated. After the T1 interval, the data transfer with respect to the memory block 0 is completed. The DMAC links to memory block 1 in accordance with the next block pointer of the memory block 0, as shown in step S34. The memory block 0 sends an interrupt signal to the DMAC, as shown in step S38. After the data transfer of the memory block 1 is completed, the memory block 2 is activated, as shown in step S36. After the DMAC updates its status after the interrupt signal from the memory block 0 is received, the memory block 0 is subsequently available.

In accordance with another embodiment of the present invention, the fulfillment of a data transfer demand determines whether a used memory block will be linked next. For example, if the size of the data transfer is 1.4 MB, while the capacity of memory block 0 plus the capacity of memory block 1 is 1.6 MB, then the transfer demand will release a right to access the bus after the access of memory block 0 and memory block 1. However, if the capacity of memory block 0 plus the capacity of memory block 1 is 1.0 MB, then the next block pointer of memory block 0 has to be updated to keep memory block 0 available after the data transfer of memory block 0 is completed. The number of linked memory blocks is not limited.

The linking table in accordance with the embodiment comprises the following information or their combination: an information source address, an object address, a block activating state, a block mask state, the number of transferred words and transfer types.

The linking structure of the DMA is changeable. For example, when the quantity of accessed data is large or unknown, the linking structure can be set to be circular. However, if the quantity of accessed data is small or known, each memory block can be linked once, or only a portion of available memory blocks used. The above applications change only one field of the linking table, and therefore the present invention provides both flexibility and convenience. In addition, the above control methods can be implemented via hardware or software methods.

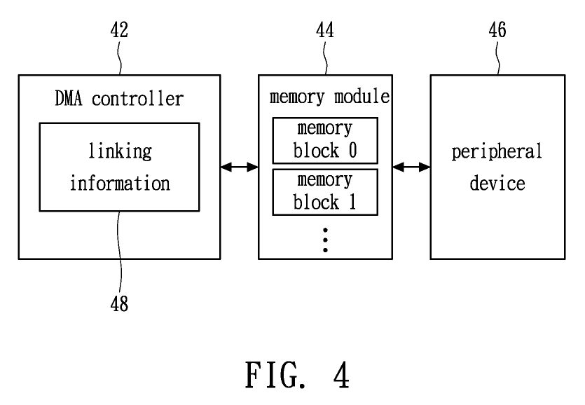

FIG. 4 shows a memory system in accordance with one embodiment of the present invention. The memory system comprises a memory module 44 and a DMA controller 42. The DMA controller 42 includes a linking table 48, which records the status of each memory block and a next block pointer, and activates a memory block in accordance with the status. When an interrupt signal corresponding to a memory block is received, the status of the accessed memory block is updated and the next block is accessed as indicated by the associated memory block pointer.

The memory block is allocated in the memory module 44. The memory blocks can be implemented by a couple of separate hardware devices or by an integrated memory with a high capacity that is internally partitioned. The capacities of the memory blocks can be the same or different, depending on the application. For example, memory blocks with the same capacity are simpler to manage, whereas memory blocks with varying capacities provide a more flexible application.

The above-mentioned status includes activated information and mask information. The activated information is used to record whether the memory block is settable, and the mask information is used to record whether the memory block is being used. In the present invention, the handover latency is reduced by setting the next memory block during activation of the memory blocks. Therefore, the total throughput and efficiency will increase, and there is more time to set DMA channels. The present method and apparatus are flexible, and can be implemented in many applications including audio/video information, memory-to-memory data transfer or best-effort applications. The present invention can improve handover latency without increasing the capacity of the memory block.

The above-described embodiments of the present invention are intended to be illustrative only. Numerous alternative embodiments may be devised by persons skilled in the art without departing from the scope of the following claims.

What is claimed is:

1. A direct memory access (DMA) controlling method comprising the steps of:
building a linking table, wherein the linking table records the status of each memory block and a pointer pointing to a next memory block;
activating a first memory block;
receiving an interrupt signal and linking to a next associated memory block after the first memory block finishes data transfers;
activating the next associated block; and
updating the linking table to release the first memory block for reuse.

2. The method of claim 1, wherein the updating step comprises the steps of:
determining whether a transfer demand has been fulfilled;
reporting the transfer demand as fulfilled and releasing a bus if the determination is affirmative; and
updating the pointer to release the first memory block for reuse if the determination is negative.

3. The method of claim 1, wherein the building step comprises the step of setting an information source address, an object address, a block activating state, a block mask state, the number of transferred words or transfer types.

4. The method of claim 3, wherein the step of activating a first memory block comprises the step of disabling an associated block mask state of the first memory block.

5. A direct memory access (DMA) controller used to control access timing of memory blocks, the DMA controller comprising a linking table configured to record the status of each memory block and a pointer pointing to a next associated memory block;
wherein the DMA controller initializes the status of each memory block and of the pointer, updates a transfer status of a memory block after receiving an interrupt signal from the memory block, and accesses the next associated memory block as indicated by the pointer.

6. The DMA controller of claim 5, wherein the status includes an activated information and a mask information, the activated information records whether the memory block accepts a setting, and the mask information records whether the memory block is activated.

7. The DMA controller of claim 5, wherein the linking table comprises one of an information source address, an object address, a block activating state, a block mask state, the number of transferred words and transfer types.

8. The DMA controller of claim 5, wherein the capacity of each memory block is not the same.

9. A memory control system, comprising:
a memory module comprising a plurality of memory blocks; and
a DMA controller configured to activate the status of each memory block and of a pointer pointing to a next associated memory block, to update a transfer state of a memory block after receiving an interrupt signal from the memory block, and to access the next associated memory block as indicated by the pointer.

10. The system of claim 9, wherein the DMA controller comprises a linking table configured to record the status of each memory block and a pointer pointing to the next associated memory block.

11. The system of claim 9, wherein the status includes an activated information and a mask information, the activated information records whether the memory block accepts a setting, and the mask information records whether the memory block is activated.

12. The system of claim 9, wherein the linking table comprises one of an information source address, an object address, a block activating state, a block mask state, the number of transferred words and transfer types.

13. The system of claim 9, wherein the capacity of each memory block is not the same.
